(19) United States
(12) Patent Application Publication
(10) Pub. No.: US 2009/0024645 A1
(43) Pub. Date: Jan. 22, 2009

(54) METHOD AND SYSTEM FOR GENERATING OFFLINE APPLICATIONS

(76) Inventor: SUDHIR KRISHNA S, Bangalore (IN)

Correspondence Address: SAP AG, 3410 HILLVIEW AVENUE, PALO ALTO, CA, 94304, US

(21) Appl. No.: 11/778,103

(22) Filed: Jul. 16, 2007

(51) Int. Cl. G06F 17/30

(52) U.S. Cl. 707/102; 707/E17.044

(57) ABSTRACT

A method and system for generating offline applications is provided. An application context for a business process is received. Based upon the application context, an application model is received. A user interface screen is extracted from the application model. A data object associated with the user interface screen is retrieved. A data relevant to the user interface screen is extracted from the data object based upon the application context. An offline application is generated from the application model and the user interface screen. The offline application and the data are packaged to generate a packaged application.

### TECHNICAL FIELD

Embodiments of the invention generally relate to computer systems, and more particularly, to a method and system for generating offline applications.

### BACKGROUND

End users frequently must work in an offline environment for various business scenarios due to bandwidth, mobility and device limitations. Traditionally, applications have been developed for online and offline environments separately involving explicit efforts. The decision of providing an offline application corresponding to an online application for a particular scenario lies with a software provider. The end users are dependent upon the decisions of the software provider in respect of the scenarios they may work offline. Thus there is a need to empower the end users to decide which business process are to be taken to the offline environment.

None of the currently existing systems provide a customized way of dynamically generating offline applications corresponding to an online application. Strictly speaking, none of the existing systems enable the end users to generate offline applications for a business process.

### SUMMARY OF THE INVENTION

Embodiments of the invention are generally directed to a method and system for generating offline applications. An application context for a business process is received. Based upon the application context, an application model is received. A user interface screen is extracted from the application model. A data object associated with the user interface screen is retrieved. A data relevant to the user interface screen is extracted from the data object based upon the application context. An offline application is generated from the application model and the user interface screen. The offline application and the data are packaged to generate a packaged application.

These and other benefits and features of embodiments of the invention will be apparent upon consideration of the following detailed description of preferred embodiments thereof, presented in connection with the following drawings in which like reference numerals are used to identify like elements throughout.

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 is a functional block diagram of a system for generating an offline application according to an embodiment of the invention.

FIG. 2 is a flow diagram of a process for generating an offline application according to an embodiment of the invention.

FIG. 3a is a first part of a flow diagram of a process for generating an offline application according to an embodiment of the invention.

FIG. 3b is a second part of the flow diagram of FIG. 3a of a process for generating an offline application according to an embodiment of the invention.

FIG. 5 is a block diagram of a system for generating an offline application useful for implementing the invention according to an embodiment of the invention.

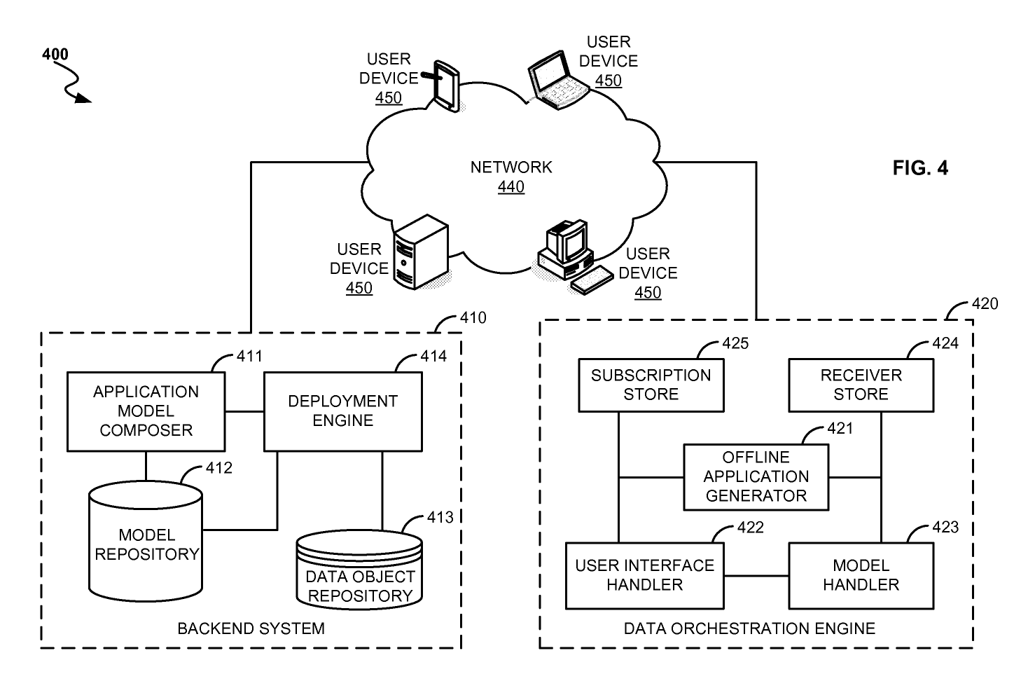

### DETAILED DESCRIPTION

Embodiments of the invention are generally directed to a method and system for generating offline applications. An application context for a business process is received. Based upon the application context, an application model is received. A user interface screen is extracted from the application model. A data object associated with the user interface screen is retrieved. A data relevant to the user interface screen is extracted from the data object based upon the application context. An offline application is generated from the application model and the user interface screen. The offline application and the data are packaged to generate a packaged application.

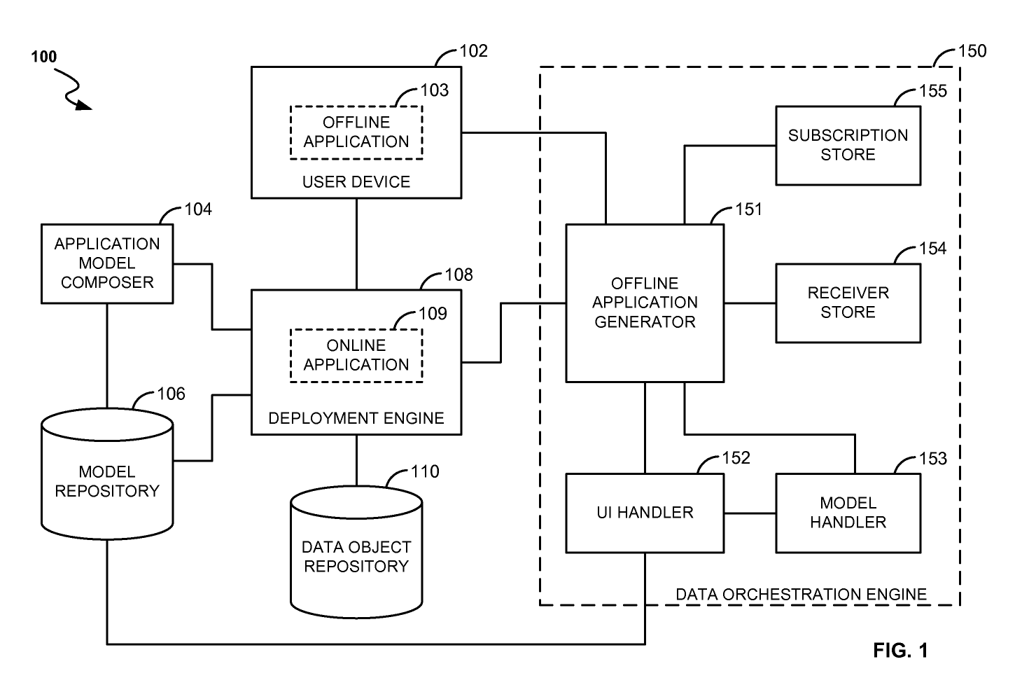

FIG. 1 is a functional block diagram of system 100 for generating an offline application according to an embodiment of the invention. Application model composer 104 is typically used to generate application models for business processes such as sales order creation, search partners, create leave request and the like. Typically, each application model generated by application model composer 104 relates to one business process. Application modeling is the art of describing objects, rules and roles and relating them in processes with a descriptive language from a particular viewpoint. For example, when the inventory for a material falls below a certain level, the inventory manager is alerted by the system to restock, but not more than a certain quantity. “Material” is the data object, “the inventory manager and the system” are the business roles and “below a certain level and not more than a certain quantity” are business rules. All of them are tied together in a business process.

The application models generated by application model composer 104 along with references to related data objects and services consumed by the application models are typically saved in model repository 106. Data objects are the basic building blocks and generally describe entities as persistency. An entity can be a customer, a product, a status, a telephone number and so on. Services are functions provided by data objects such as obtaining a list of customers, identifying all the products from a product data object using a product category and the like. Data objects are stored in data object repository 110.

Based upon the application model and data from the related data objects and services, online application 109 is generated and deployed on deployment engine 108 such as a J2EE engine. A user working on user device 102 may now log on to deployment engine 108 and start working on online application 109. Data orchestration engine 150 is responsible for generating offline application 103 for business processes. Data orchestration engine 150 includes offline application generator 151, user interface handler 152, model handler 153, receiver store 154 and subscription store 155. While working on online application 109, the user may be provided with a means to select either a part or the entire online application 109 for generating offline application 103. The means to select may include a drop down menu option, a toolbar button, a check box, a radio button or the like. Based upon the user selection, a request for generating offline application 103 is passed on to offline application generator 151. Offline application generator 151 retrieves an application context of online application 109 from deployment engine 108. The application context may include search parameters, user inputs and the like. Offline application generator 151 hands over the application context, typically simultaneously, to user interface handler 152 and model handler 153.

User interface handler 152 retrieves the application model from model repository 106 based upon the application context received from offline application generator 151. The application model generally has multiple user interface screens as in a guided procedure. User interface handler 152 extracts all the user interface screens of the application model one by one. The user interface screens extracted from the application model are handed over to model handler 153. According to an embodiment of the invention as and when a user interface screen is extracted by user interface handler 152, the user interface screen is passed on to model handler 153. Once all the user interface screens have been extracted from the application model, user interface handler 152 generates offline application 103 from the application model and the user interface screens. Offline application 103 is then passed on to offline application generator 151.

Based upon the application context received from offline application generator 151 and the user interface screens received from user interface handler 152, model handler 153 retrieves one or more data objects and services associated with each of the user interface screen from data object repository 110. The services are invoked by model handler 153 from a backend system such as an (Enterprise Resource Planning) ERP system, a (Customer Relationship Management) CRM system or the like. For example if a user input is used for searching a ‘sales order data object’, a first service may be using ‘customer number’ from the ‘sales order data object’ for finding the customer from a ‘customer data object’. Similarly a second service may be using ‘product category’ from the sales order data object for identifying all the products from a ‘product data object’.

Based upon the application context and the user interface screens, model handler 153 extracts data relevant to each of the user interface screens from the data objects. Once retrieving the data objects and extracting the data have been completed, model handler 153 packages the data and transfers it to offline application generator 151.

Offline application generator 151 saves the offline application received from user interface handler 152 and the data received from model handler 153 in receiver store 154. A subscription is created for each of the users using user device 102 to enable the users to request for offline application 103 while they are not online with the backend system. The subscriptions are stored in subscription store 155. The subscriptions typically enable offline application generator 151 to identify users, authenticate users and process user requests. Thus, if a request is received from a user in respect of offline application 103 stored in receiver store 154, offline application generator 151 retrieves offline application 103 and the data from receiver store 154 and deploys offline application 103 along with the data on user device 102 based upon the user's subscription. Offline application 103 and the data stored in receiver store 154 are typically packaged before deployment on user device 102. This enables a user to work on a business process task offline and synchronize data from user device 102 with a backend system only occasionally.

According to an embodiment of the invention if a request is received from a user in respect of an application for which offline application 103 is already stored in receiver store 154, offline application generator 151 first checks with model repository 106 for any changes in the application model. If the application model has changed, offline application generator 151 re-generates offline application 103 as explained above. If no change in the application model has occurred, offline application generator 151 retrieves offline application 103 and the data from receiver store 154 and deploys offline application 103 along with the data on user device 102 based upon the user's subscription.

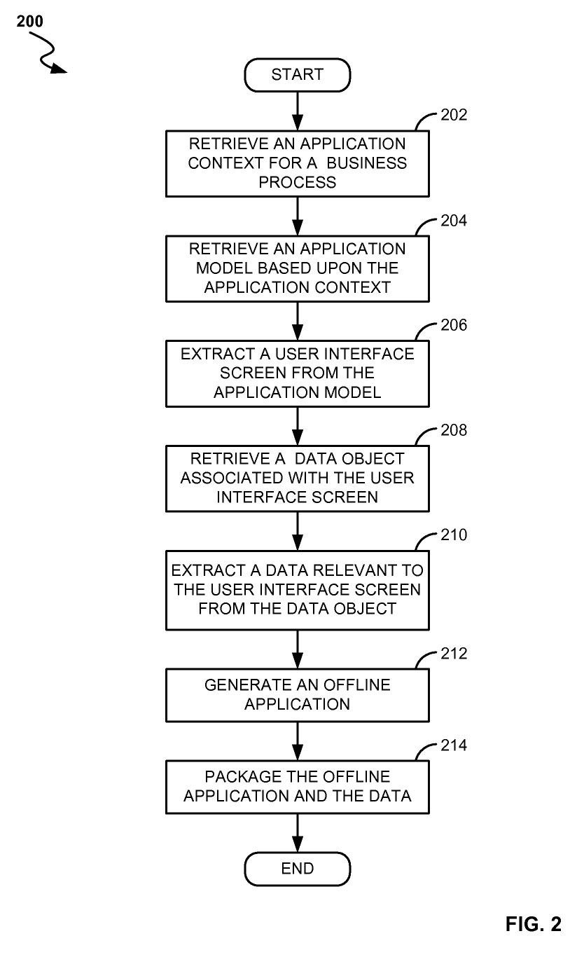

FIG. 2 is a flow diagram of a process 200 for generating an offline application according to an embodiment of the invention. In process block 202, an application context is retrieved for a business process. In process block 204, an application model is retrieved based upon the application context. A user interface screen is extracted from the application model in process block 206. A data object associated with the user interface screen is retrieved in process block 208. In process block 210, a data relevant to the user interface screen is extracted from the data object based upon the application context. In process block 212, an offline application is generated from the application model and the user interface screen. Finally in process block 214, the offline application and the data are packaged. Process 200 is then terminated.

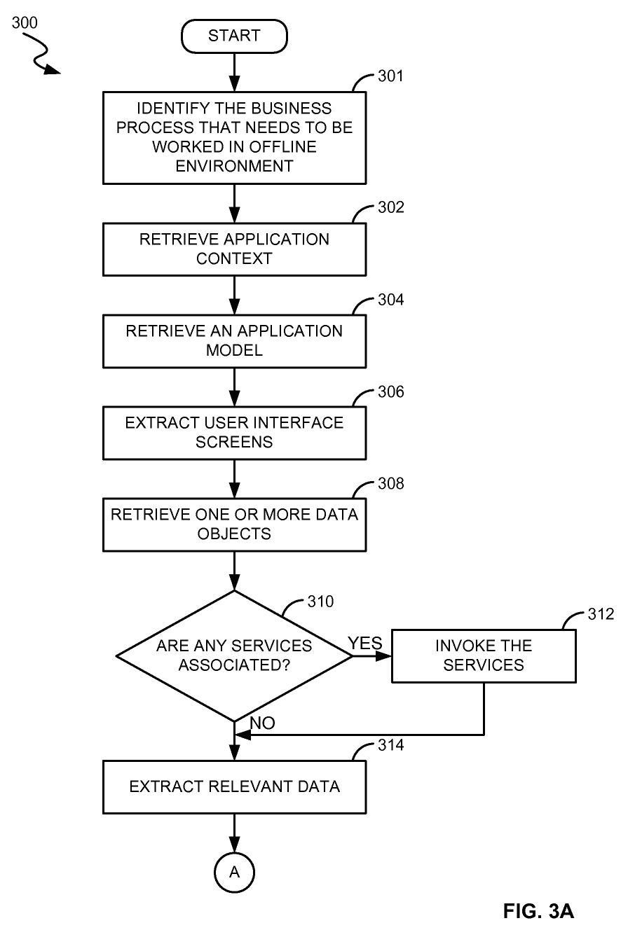

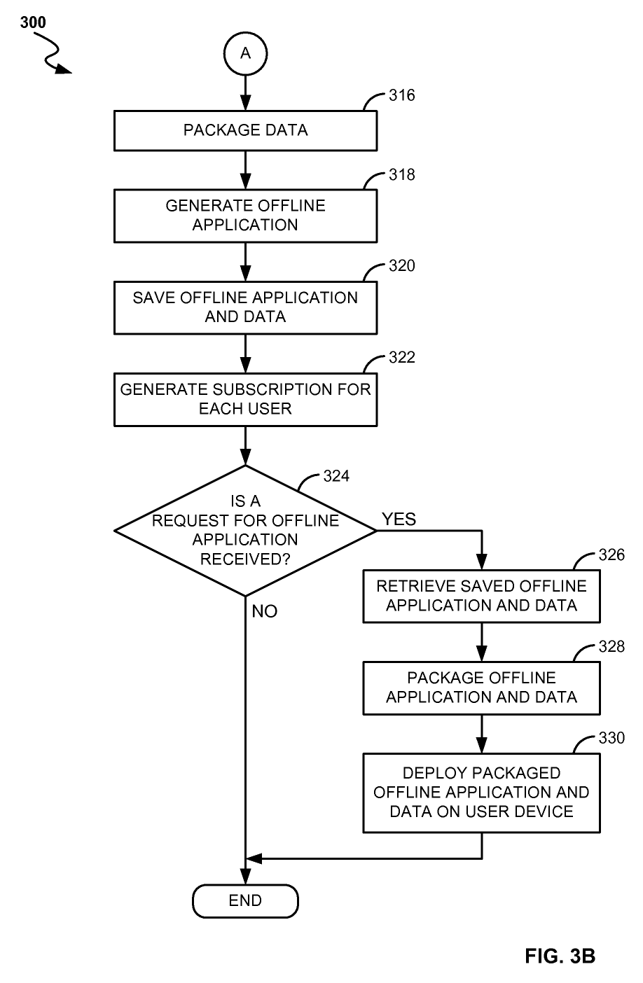

FIG. 3a is a first part of a flow diagram of a process 300 for generating an offline application according to an embodiment of the invention. In process block 301, a business process is identified that needs to be worked upon in an offline environment. Typically a user while working on an online application for the business process through a user device is provided with a means to select either a part or entire online application for generating an offline application. The means to select may include a drop down menu option, a tool bar button, a check box, a radio button or the like. In process block 302, based upon the user selection an application context is retrieved from a deployment engine such as a J2EE engine. In process block 304, an application model is retrieved from a model repository based upon the retrieved application context. In process block 306, user interface screens are extracted from the application model. In process block 308, one or more data objects associated with each of the user interface screens are retrieved from a data object repository. In decision block 310, if any services are associated with any of the user interface screens, process 300 moves to process block 312 where the services are invoked from a backend system such as an (Enterprise Resource Planning) ERP system, (Customer Relationship Management) CRM system or the like. In decision block 310, if there are no services associated with the user interface screens, process 300 moves to process block 314 where data relevant to each of the user interface screens is extracted.

FIG. 3b is a second part of the flow diagram of FIG. 3a of a process 300 for generating an offline application according to an embodiment of the invention. After the extraction of the data relevant to each of the user interface screens in process block 314 (see FIG. 3a), the process 300 moves to process block 316 where the data is packaged. In process block 318, an offline application is generated from the application model and the user interface screens. In an embodiment of the invention the offline application is generated once all the user interface screens are extracted from the application model. In process block 320, the offline application and the data are saved typically in a receiver store. In process block 322, a subscription is generated for each user. In decision block 324, if a request for the offline application is received, process 300 moves to process block 326 where the saved offline application and data are retrieved. In process block, 328, the offline application and the data are packaged. In process block 330, the packaged offline application and data are deployed on the user device. Process 300 is then terminated. In decision block 324, if there is no request for the offline application is received, process 300 is terminated.

FIG. 4 is a block diagram of a system 400 for generating an offline application useful for implementing the invention according to an embodiment of the invention. System 400 includes user devices 450, backend system 410 and data orchestration engine 420. According to an embodiment of the invention each of the devices 450, backend system 410 and data orchestration engine 420 are connected to each other by network 440. Backend system 410 further includes application model composer 411, model repository 412, data object repository 413 and deployment engine 414. Application model composer 411 is typically connected with model repository 412 and deployment engine 414. In addition, deployment engine 414 is connected with model repository 412 and data object repository 413. Data orchestration engine 420 further includes offline application generator 421, user interface handler 422, model handler 423, receiver store 414 and subscription store 425. Offline application generator 421 is typically connected to user interface handler 422, model handler 423, receiver store 424 and subscription store 425. In addition user interface handler 422 is generally connected with model handler 423. The devices 450 may include a personal computer, hand held device, mobile phone or the like.

Application model composer 411 is typically used to generate application models for business processes such as sales order creation, search for partners, create leave request and the like. Typically, each application model generated by application model composer 411 relates to one business process.

The application models generated by application model composer 411 along with references to related data objects and services consumed by the application models are typically saved in model repository 412. Data objects are stored in data object repository 413.

Based upon the application model and data from the related data objects and services, an online application is generated and deployed on deployment engine 414 such as a J2EE engine. A user working on one of the user devices 450 may now log on to the deployment engine 414 and start working on the online application. Data orchestration engine 420 is responsible for generating offline applications for business processes. While working on the online application through one of the user devices 450, the user may be provided with a means to select either a part or the entire online application for generating an offline application. The means to select may include a drop down menu option, a toolbar button, a check box, a radio button or the like. Based upon the user selection, a request for generating the offline application is passed on to offline application generator 421. Offline application generator 421 retrieves an application context of the online application from deployment engine 414. The application context may include search parameters, user inputs and the like. Offline application generator 421 transmits the application context, typically simultaneously, to user interface handler 422 and model handler 423.

User interface handler 422 retrieves the application model from model repository 412 based upon the application context received from offline application generator 421. The application model generally has multiple user interface screens as in a guided procedure. User interface handler 422 extracts all the user interface screens of the application model one by one. The user interface screens extracted from the application model are transmitted to model handler 423. According to an embodiment of the invention as and when a user interface screen is extracted by user interface handler 422, the user interface screen is transmitted to model handler 423. Once all the user interface screens have been extracted from the application model, user interface handler 422 generates the offline application from the application model and the user interface screens. The offline application is then transmitted to offline application generator 421.

Based upon the application context received from offline application generator 421 and the user interface screens received from user interface handler 422, model handler 423 retrieves one or more data objects and services associated with each of the user interface screen from data object repository 413. The services are invoked by model handler 423 from backend system 410. Backend system 410 may include an (Enterprise Resource Planning) ERP system, a (Customer Relationship Management) CRM system or the like.

Based upon the application context and the user interface screens, model handler 423 extracts data relevant to each of the user interface screens from the data objects. Once retrieving the data objects and extracting the data have been completed model handler 423 packages the data and transfers it to offline application generator 421.

Offline application generator 421 saves the offline application received from user interface handler 422 and the data received from model handler 423 in receiver store 424. A subscription is generated for each of the users using user devices 450 to enable the users to request for the offline application while they are not online with the backend system. The subscriptions are generally stored in subscription store 425. The subscriptions typically enable offline application generator 421 to identify users, authenticate users and process user requests. Thus, if a request is received from one of the user devices 450 for the offline application stored in receiver store 424, offline application generator 421 retrieves the offline application and the data from receiver store 424 and deploys the offline application along with the data on user device 450 based upon the user's subscription. The offline application and the data stored in receiver store 424 are typically packaged before deployment on user device 450. This enables a user to work on a business process task offline and synchronize data from user device 450 with a backend system only occasionally.

According to an embodiment of the invention if a request is received from a user in respect of an application for which an offline application is already stored in receiver store 424, offline application generator 421 first checks with model repository 412 for any changes in the application model. If the application model has been changed, offline application generator 421 re-generates the offline application as explained above. If no change in the application model has occurred, offline application generator 421 retrieves the offline application and the data from receiver store 424 and deploys the offline application along with the data on user device 450 based upon the user's subscription.

The particular methods associated with embodiments of the invention are described in terms of computer software and hardware with reference to flowcharts. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

What is claimed is:

1. A method comprising:
receiving an application context for a business process;
receiving an application model based upon the application context;
extracting a user interface screen from the application model;
retrieving a data object associated with the user interface screen;
extracting a data relevant to the user interface screen from the data object based upon the application context;
generating an offline application from the application model and the user interface screen; and
packaging the offline application and the data to generate a packaged application.

2. The method of claim 1 further comprising the step of identifying the business process to be used in an offline environment.

3. The method of claim 1 further comprising
identifying a service associated with the user interface screen; and
invoking the service from a backend system.

4. The method of claim 1, wherein the application model is generated using an application model composer.

5. The method of claim 1 further comprising:
generating a subscription for a user; and
checking for a change in the business process if a request for the business process is received from the user;
retrieving the offline application and the data for deployment on a user device if there is no change in the business process; and
retrieving the application context to re-generate the offline application if there is a change in the business process.

6. A system comprising:
an offline application generator for retrieving an application context for a business process and for packaging an offline application;
a user interface handler electronically coupled to the offline application generator, for extracting a user interface screen from the application model and generating the offline application from the application model and the user interface screen; and
a model handler electronically coupled to the offline application generator and the user interface handler for extracting a data relevant to the user interface screen from the data object based upon the application context,

7. The system of claim 6 further comprising an model repository electronically coupled to the user interface handler, the user interface handler retrieving the application model from the model repository.

8. The system of claim 6 further comprising a data object repository electronically coupled to the model handler, the model handler retrieving the data object from the data object repository.

9. The system of claim 6 further comprising a subscription store electronically coupled to the offline application generator, the offline application generator generating a subscription for a user and storing the subscription in the subscription store.

10. The system of claim 6 further comprising a user device electronically coupled to the offline application generator, the offline application generator deploying the offline application and the data on the user device.

11. A machine-accessible medium that provides instructions that, when executed by a machine, cause the machine to perform operations comprising:
receiving an application context for a business process;
receiving an application model based upon the application context;
extracting a user interface screen from the application model;
retrieving a data object associated with the user interface screen;
extracting a data relevant to the user interface screen from the data object based upon the application context;
generating an offline application from the application model and the user interface screen; and
packaging the offline application and the data to generate a packaged application.

12. The machine-accessible medium of claim 11 further providing instructions which when executed by the machine cause the machine to perform further operations comprising the step of identifying the business process that needs to be used in an offline environment.

13. The machine-accessible medium of claim 11 further providing instructions which when executed by the machine cause the machine to perform further operations comprising:
identifying a service associated with the user interface screen; and
invoking the service from a backend system.

14. The machine-accessible medium of claim 11, wherein the application model is generated using an application model composer.

15. The machine-accessible medium of claim 11 further providing instructions which when executed by the machine cause the machine to perform further operations comprising:
generating a subscription for a user;
checking for a change in the business process if a request for the business process is received from the user;
retrieving the offline application and the data for deployment on a user device if there is no change in the business process; and
retrieving the application context to re-generate the offline application if there is a change in the business process.
